(19) United States
(12) Patent Application Publication
(10) Pub. No.: US 2004/0230680 A1
(43) Pub. Date: Nov. 18, 2004

(54) Computer-based techniques providing greedy approaches for facility location and other similar problems

(76) Inventors: Kamal Jain, Bellevue, WA (US); Mohammad Mahdian, Cambridge, MA (US); Amin Saberi, Atlanta, GA (US)

Correspondence Address: LEE & HAYES PLLC, 421 W RIVERSIDE AVENUE SUITE 500, SPOKANE, WA, 99201

(21) Appl. No.: 10/440,021

(22) Filed: May 16, 2003

(51) Int. Cl. G06F 15/173

(52) U.S. Cl. 709/226

(57) ABSTRACT

Methods and apparatuses are provided that employ an improved greedy algorithm for addressing NP-Hard problems and others like them. The improved greedy algorithm considers possible local savings while also remaining significantly fast.

### TECHNICAL FIELD

This invention relates to computers and software, and more particularly to methods and apparatuses for providing computer-based techniques providing greedy approaches for facility location, resource allocation, and/or other like problems/decisions.

### BACKGROUND OF THE INVENTION

Numerous classical and contemporary problems are integer optimization problems that are intractable. Such problems are commonly referred to as NP-Hard problems and often addressed with heuristics that provide a solution, but not always information on the solution's quality. An approximation algorithms' framework, on the other hand, usually provides a guarantee on the quality of the solution obtained. Various frameworks have been used to develop computer-based algorithms in specific problem areas with increasingly improved performance.

One example of an NP-Hard problem is the classical problem of facility location. The facility location problem is essentially the problem of determining were to locate facilities such that the intended users or clients of the facilities are properly served and costs are reduced or minimized. Here, for example, the facility may include a fire station, a retail store, a factory, a ware house, an office complex, or other like buildings/structures. Another example is a resource allocation problem associated with providing access and/or services to clients in a substantially efficient manner. In the context of the information age, the resource allocation problem may arise in determining where to locate computer/communication resources such as servers, routers, switches, hubs, networks, antennas, and the like.

These and other like problems are typically considered NP-Hard problems, because it is widely believed that one cannot find the optimal solution (e.g., a minimal cost solution, minimal access time solution, etc.) within a reasonable amount of time. One reason for this assumption is that there are usually several or possibly too many variables/options to consider or otherwise accurately account for.

There is a continuing need, therefore, for improved algorithms and related methods and apparatuses for addressing such problems and others like them.

### SUMMARY OF THE INVENTION

Improved algorithms and related methods and apparatuses are provided for addressing NP-Hard such problems and others like them. Examples of such problems include, but are not limited to, facility location problems and resource allocation problems. Those skilled in the art will recognize that there are many other problems that can essentially be framed as a facility location or a resource allocation problem.

In accordance with certain aspects of the present invention, a significantly fast algorithm is provided that approximately solves such problems. The algorithm can be computer-based or otherwise implemented through some form of logic. As used herein, the term logic refers to any form or combined forms of logic, for example, hardware, firmware and/or software logic.

In accordance with certain exemplary implementations of the present invention, the approximation guarantee of the algorithm can be as low as about 1.61. This means that the solution obtained is guaranteed to be at lost only 61 percent worse then the optimal solution. This is only a pessimistic guarantee, for typical examples, the algorithm usually performs within a few percentage points of the optimal solution.

The above stated needs and others are met, for example, by a method for use in a computing or other like device. The method includes identifying a plurality of potential “resources” and a plurality of “users”. For each of the users, an access parameter is also identified for each of the potential resources.

The method then enters and iterative process beginning with, for each of the potential resources, establishing a plurality of user groups and determining a corresponding group access parameter. For example, the group access parameter may be the average access cost for users in the group to access the resource. Next the method includes selecting one of the group parameters. This may include selecting the lowest average group access parameter, for example, out of all of those determined. The corresponding potential resource for the selected (picked) group parameter is then re-identified as a candidate resource and each user in the corresponding user group is then assigned to the candidate resource, provided that the user has not already been assigned to another candidate resource. If and once a plurality candidate resources have been identified, then for each user assigned to one of the candidate resources, the method consider whether to re-assign the user to a different candidate resource based at least on a comparison of access parameters associated with the user and each of the candidate resources. In certain implementations, the re-assignment of users provides for a local savings. The method then iterates back to the beginning until each of the users has been assigned to a corresponding candidate resource.

In this example and others herein, potential resources include any physical item or a service that is suitable for being accessed in some manner by at least one of the users. By way of example and not limitation, a potential resource may include a facility, a building, a platform, a business location, a store, an office, a warehouse, a factory, a medical facility, a port, a service capability, a computing resource, a server, a communication resource, an antenna, a satellite, an information repository, a database, a public utility resource, a natural resource, a crop, a supply, a transportation resource, an education resource, an entertainment resource, and the like.

As for applicable users, anyone or anything suitable for accessing at least one of the potential resources may be considered a user in this example. Hence, users may include one person, a group of people, a business, a consumer, a client, geographically-related resource users, a city, an entity, an organization, a student, a patient, a subscriber, an animal, a computing device, a computer program, a communication device, a receiver, a transmitter, a transportation device, and the like. These examples are not intended to limit the scope of the term “user”.

This exemplary method may also include identifying a minimal candidate resource threshold or other like value/test. After completing the iteration and assigning users to resources, the method would then, determine if each of the candidate resources satisfies the minimal candidate resource threshold, e.g., based on the number of the users assigned to the candidate resource. If the candidate resource does not satisfy the minimal candidate resource threshold, then for each the user assigned to the candidate resource, the method would re-assign the user to another one of the candidate resources based at least on the access parameters associated with the user. When this happens and all of the users are re-assigned, then the losing candidate resource is re-identified as one of the potential resources.

Once the candidate resources have been settled upon, then method would then include outputting the results, for example, to a data storage device or other computer-readable media, a display screen, a printer, a network, etc.

### BRIEF DESCRIPTION OF THE DRAWINGS

A more complete understanding of the various methods and apparatuses of the present invention may be had by reference to the following detailed description when taken in conjunction with the accompanying drawings wherein:

FIG. 1 is a block diagram depicting an exemplary computer system suitable for use performing the novel algorithm in logic, in accordance with certain exemplary implementations of the present invention.

FIG. 2 is a block diagram illustratively depicting a plurality of possible facilities or resources, a plurality of clients that the algorithm assigns or otherwise associates each with at least one of the facilities/resources, and “costs” for the client to access or otherwise use a facility/resource represented by the exemplary interconnecting arrows, in accordance with certain exemplary implementations of the present invention.

FIG. 3 is a flow diagram depicting a method for a facility/resource algorithm that can be implemented in logic, in accordance with certain exemplary implementations of the present invention.

FIG. 4 is an illustrative graph depicting results of an optimization method, in accordance with certain exemplary implementations of the present invention.

### DETAILED DESCRIPTION

Description Overview

This description is arranged to present the reader with an exemplary computing environment that may be used for processing data according to the techniques and/or exemplary algorithms described herein. Following that, the techniques are described in sufficient mathematical detail to allow those skilled in the art to apply such techniques to various problems using a computer or like device. An exemplary method based on the mathematical techniques, is then presented for use within logic such as that available in the exemplary computing environment.

Exemplary Computing Environment

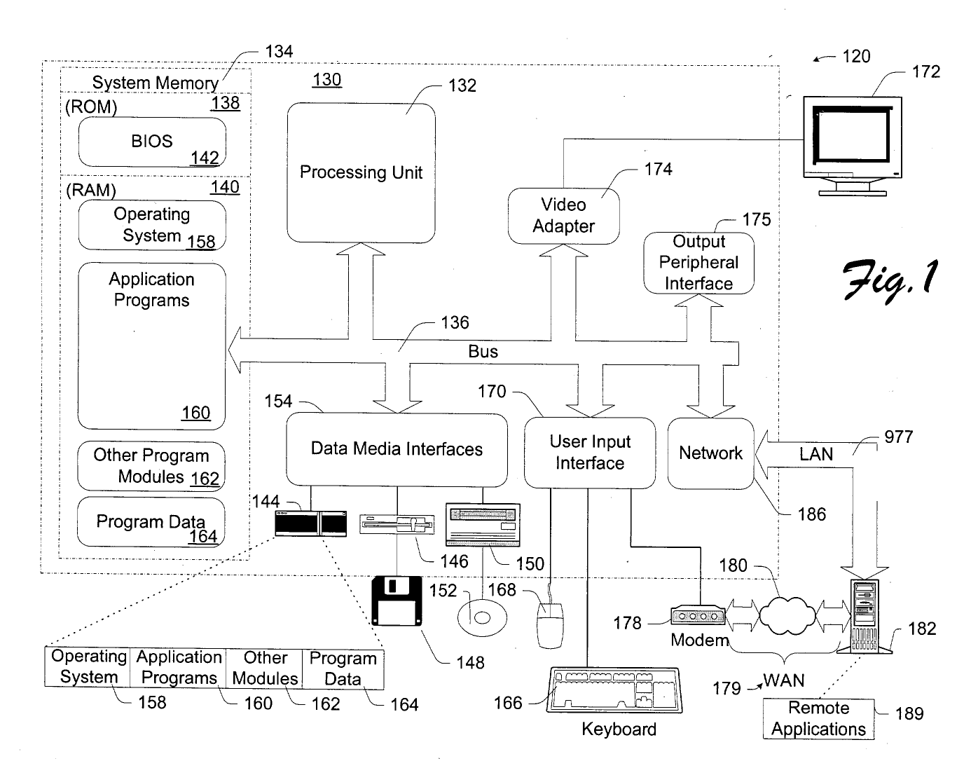

FIG. 1 illustrates an example of a suitable computing environment 120 on which the subsequently described methods and arrangements may be implemented.

Exemplary computing environment 120 is only one example of a suitable computing environment and is not intended to suggest any limitation as to the scope of use or functionality of the improved methods and arrangements described herein. Neither should computing environment 120 be interpreted as having any dependency or requirement relating to any one or combination of components illustrated in computing environment 120.

The improved methods and arrangements herein are operational with numerous other general purpose or special purpose computing system environments or configurations.

As shown in FIG. 1, computing environment 120 includes a general-purpose computing device in the form of a computer 130. The components of computer 130 may include one or more processors or processing units 132, a system memory 134, and a bus 136 that couples various system components including system memory 134 to processor 132.

Bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) Ibus, Enhanced ISA (EISA) bus, Video Electronics Standards Association (VESA) local bus, and Peripheral Component Interconnects (PCI) bus also known as Mezzanine bus.

Computer 130 typically includes a variety of computer readable media. Such media may be any available media that is accessible by computer 130, and it includes both volatile and non-volatile media, removable and non-removable media.

In FIG. 1, system memory 134 includes computer readable media in the form of volatile memory, such as random access memory (RAM) 140, and/or non-volatile memory, such as read only memory (ROM) 138. A basic input/output system (BIOS) 142, containing the basic routines that help to transfer information between elements within computer 130, such as during start-up, is stored in ROM 138. RAM 140 typically contains data and/or program modules that are immediately accessible to and/or presently being operated on by processor 132.

Computer 130 may further include other removable/non-removable, volatile/non-volatile computer storage media. For example, FIG. 1 illustrates a hard disk drive 144 for reading from and writing to a non-removable, non-volatile magnetic media (not shown and typically called a “hard drive”), a magnetic disk drive 146 for reading from and writing to a removable, non-volatile magnetic disk 148 (e.g., a “floppy disk”), and an optical disk drive 150 for reading from or writing to a removable, non-volatile optical disk 152 such as a CD-ROM, CD-R, CD-RW, DVD-ROM, DVD-RAM or other optical media. Hard disk drive 144, magnetic disk drive 146 and optical disk drive 150 are each connected to bus 136 by one or more interfaces 154.

The drives and associated computer-readable media provide nonvolatile storage of computer readable instructions, data structures, program modules, and other data for computer 130. Although the exemplary environment described herein employs a hard disk, a removable magnetic disk 148 and a removable optical disk 152, it should be appreciated by those skilled in the art that other types of computer readable media which can store data that is accessible by a computer, such as magnetic cassettes, flash memory cards, digital video disks, random access memories (RAMs), read only memories (ROM), and the like, may also be used in the exemplary operating environment.

A number of program modules may be stored on the hard disk, magnetic disk 148, optical disk 152, ROM 138, or RAM 140, including, e.g., an operating system 158, one or more application programs 160, other program modules 162, and program data 164.

The improved methods and arrangements described herein may be implemented within operating system 158, one or more application programs 160, other program modules 162, and/or program data 164.

A user may provide commands and information into computer 130 through input devices such as keyboard 166 and pointing device 168 (such as a “mouse”). Other input devices (not shown) may include a microphone, joystick, game pad, satellite dish, serial port, scanner, camera, etc. These and other input devices are connected to the processing unit 132 through a user input interface 170 that is coupled to bus 136, but may be connected by other interface and bus structures, such as a parallel port, game port, or a universal serial bus (USB).

A monitor 172 or other type of display device is also connected to bus 136 via an interface, such as a video adapter 174. In addition to monitor 172, personal computers typically include other peripheral output devices (not shown), such as speakers and printers, which may be connected through output peripheral interface 175.

Computer 130 may operate in a networked environment using logical connections to one or more remote computers, such as a remote computer 182. Remote computer 182 may include many or all of the elements and features described herein relative to computer 130.

Logical connections shown in FIG. 1 are a local area network (LAN) 177 and a general wide area network (WAN) 179. Such networking environments are commonplace in offices, enterprise-wide computer networks, intranets, and the Internet.

When used in a LAN networking environment, computer 130 is connected to LAN 177 via network interface or adapter 186. When used in a WAN networking environment, the computer typically includes a modem 178 or other means for establishing communications over WAN 179. Modem 178, which may be internal or external, may be connected to system bus 136 via the user input interface 170 or other appropriate mechanism.

Depicted in FIG. 1, is a specific implementation of a WAN via the Internet. Here, computer 130 employs modem 178 to establish communications with at least one remote computer 182 via the Internet 180.

In a networked environment, program modules depicted relative to computer 130, or portions thereof, may be stored in a remote memory storage device. Thus, e.g., as depicted in FIG. 1, remote application programs 189 may reside on a memory device of remote computer 182. It will be appreciated that the network connections shown and described are exemplary and other means of establishing a communications link between the computers may be used.

Improved Algorithm Overview

A simple and natural greedy algorithm is presented herein for the metric uncapacitated facility location problem achieving an approximation guarantee of 1.61 whereas the best previously known was 1.73. The greedy algorithm has a property which allows one to apply the technique of Lagrangian relaxation. Using this property, for example, one can find even better approximation algorithms for many variants of the facility location problem, such as the capacitated facility location problem with soft capacities, a common generalization of the k-median and facility location problem, and others. Also provided is a lower bound on the approximation of the k-median problem.

Introduction

In the following exemplary (uncapacitated) facility location problem, assume that one has a set F of n_{f} facilities and a set C of n_{c} cities. For every facility iεF, a nonnegative number fᵢ is given as the opening cost of facility i. Furthermore, for every city jεC and facility iεF, there is a connection cost (e.g., access cost, service cost, etc.) cᵢⱼ between city j and facility i.

The objective is to open a subset of the facilities in F, and connect each city to an open facility so that the total cost is substantially minimized. This exemplary mathematical description considers the metric version of this problem, i.e., the connection costs satisfy the triangle inequality.

Such problems have many applications in operations research, and recently in the network design problems such as placement of routers and caches, agglomeration of traffic or data, and web server replications in a content distribution network (CDN), for example. In the last decade the problem was studied extensively from the perspective of approximation algorithms.

Different approaches such as LP rounding, primal-dual method, local search, and combinations of these methods with cost scaling and greedy post-processing are used to solve the facility location problem and its variants. Until now, the best known approximation algorithm for this problem achieved a factor of 1.728. To achieve this factor, the conventional algorithm essentially combined the ideas of cost scaling, greedy augmentations, and a primal-dual algorithm of to marginally improve a (1+2/e) approximation algorithm based on LP-rounding techniques. One potential drawback of this type of conventional algorithm is that it needs to solve large linear programs and therefore has a long processing running time/requirement. Using about the same ideas, others have presented an O(n³) algorithm with approximation ratio 1.853. In has been shown that a simple greedy algorithm achieves an approximation ratio of 1.861 in O(n² log n) time. For the case of sparse graph, still others have provided faster (3+o(1))-approximation algorithms. Regarding hardness results, it is believed that it is likely impossible to get an approximation guarantee of 1.463 for the metric facility location problem, unless NP⊂DTIME[n^{O(loglog n)}].

Here, in the description, simple and natural heuristic algorithms/techniques are provided for the facility location problem and others like it, achieving an approximation factor of 1.61 with the running time O(n³).

The exemplary algorithm is an improvement on conventional greedy algorithms. The technique used for the analysis of this algorithm is to express different constraints that are imposed by the problem statement or by the algorithm as linear inequalities, so that one gets a bound on the approximation ratio (or in the exemplary case, the exact approximation ratio) of the algorithm by solving a particular series of linear programs, which are referred to herein as factor-revealing LP. This scheme has some similarity to the idea of the LP bound in coding theory (e.g., LP bound gives the best known bounds on the minimum distance of a code with a given rate by bounding the solution of a linear program that contains various linear constraints, mainly MacWilliams identities). In the context of approximation algorithms, the idea of LP bound has been used for computing the approximation algorithm of an algorithm for the minimum latency problem. This conventional technique enables one to compute the approximation ratio of the algorithm empirically, and provides a straightforward way to prove a bound on the approximation ratio. In the case of the novel algorithm presented herein, this technique also enables one to compute the tradeoff between the approximation ratio of facility costs versus the approximation ratio of the connection costs. The exemplary mathematical algorithm, its analysis, and a discussion about this tradeoff are presented in the following sections.

Among all previously known facility location algorithms, the primal-dual algorithm is perhaps the most versatile one in that it can be used to obtain algorithms for other variants of the problem, such as k-median, a common generalization of k-median and facility location, capacitated facility location with soft capacities, prize collecting facility location, and facility location with outliers. This versatility is partly because of the simplicity of that algorithm, and partly (in the case of k-median, common generalization of k-median and facility location, and capacitated facility location) because of a property of the algorithm which allows one to apply the Lagrangian relaxation technique.

The novel mathematical algorithm presented herein has a property, which will be referred to as the Lagrangian multiplier preserving property, with an approximation factor that represents an increase over the primal-dual algorithm. This enables one to obtain algorithms for some variants of the facility location problem. In particular, in this description an algorithm is presented that solves a common generalization of the facility location problem and k-median within a factor of 4. In this exemplary problem, which is referred to herein as the k-facility location problem, an instance of the facility location problem and an integer k are given and the objective is to find a substantially cheap/low-cost solution that opens at most k facilities.

The k-median problem is a special case of this problem in which all opening costs are 0. The k-median problem has been studied extensively and the best known approximation algorithm for this problem to date achieves a factor of 3+ε. The k-facility location problem has also been studied in operations research, and the best previously known approximation factor for this problem was 6.

The Lagrangian multiplier preserving property of the novel algorithm presented herein enables one to produce a 3-approximation algorithm for a capacitated version of the facility location problem, in which one is allowed to open more than one facility at any location. This problem may be referred to as the capacitated facility location problem with soft capacities. The best previously known approximation algorithm for this problem has a factor of 3.46, and is based on a facility location algorithm together with the observation that any α-approximation algorithm for the uncapacitated facility location problem yields an algorithm with an approximation ratio of 2α for the capacitated facility location problem with soft capacities.

As mentioned, in this description some lower bounds are also proven. Here, for example, it is shown that the k-median problem cannot be approximated within a factor strictly less than 1+2/e, unless NP⊂DTIME[n^{O(loglog n)}]. This is an improvement over the conventionally known lower bound of 1+1/e. Note that this result shows that k-median is a strictly harder problem to approximate than the facility location problem. As will be seen, a lower bound is the best tradeoff one can hope to achieve between the approximation factors for the facility cost and the connection cost in the facility location problem.

Exemplary Algorithm for the Metric Facility Location Problem

As is known, the facility location problem may be captured by commonly known integer programs. For the sake of convenience, in this description another equivalent formulation for the problem is provided.

Thus, let us say that a star consists of one facility and several cities. The cost of a star is the sum of the opening cost of the facility and the connection costs between the facility and all the cities in the star.

Let S be the set of all stars. The facility location problem can be thought of as picking a minimum cost set of stars such that each city is in at least one star. This problem can be captured by the following integer program. In this program, x_{S} is an indicator variable denoting whether star S is picked and c_{S} denotes the cost of star S.

$$Thus , \\ minimize \\ {\sum }_{S ∈ S} {c}_{S} {x}_{S} \\ subject to ∀ j ∈ C \text{:} {\sum }_{S \text{:} j ∈ S} {x}_{S} \geq 1 \\ ∀ S ∈ S \text{:} {x}_{S} ∈ \{ 0 , 1 \} \qquad ( 1 )$$

The LP-relaxation of this program is:

$$minimize \\ {\sum }_{S ∈ S} {c}_{S} {x}_{S} \\ subject to ∀ j ∈ C \text{:} {\sum }_{S \text{:} j ∈ S} {x}_{S} \geq 1 \\ ∀ S ∈ S \text{:} {x}_{S} \geq 0 \qquad ( 2 )$$

The dual program is:

$$maximize \\ {\sum }_{j ∈} C {α}_{j} \\ subject to ∀ S ∈ S \text{:} {\sum }_{j ∈ S ⋂} C {α}_{j} \leq {c}_{S} \\ ∀ j ∈ C \text{:} {α}_{j} \geq 0 \qquad ( 3 )$$

One may think of the variable αⱼ in the dual program as the share of city j of the total expenses. It is clear from LP-duality that if an algorithm finds a solution for the facility location problem of cost T, and values αⱼ for jεC such that

Σ_{jεC}αⱼ=T

and for every star S,

Σ_{jεS∩C}αⱼ≦γc_{S}

for some fixed number γ≧1, then the approximation ratio of the algorithm is at most γ.

Another way of looking at this is to consider an optimal solution for an instance of the problem. For every facility i that is opened in this solution and the collection A of cities that are connected to it, one may write the inequality Σ_{jεA}αⱼ≦γ(fᵢ+Σ_{jεA}Cᵢⱼ). By adding up these inequalities, one will find out that the cost of the solution presented herein is at most γ times the cost of the optimal solution. This fact is the basis of the analysis presented herein.

This method, which is called dual fitting, can be considered a primal-dual type method. The only difference is that in primal-dual algorithms one usually relaxes the complementary slackness conditions to obtain a solution for the primal and a solution for the dual so-that the ratio of the values of the objective functions for these two solutions is bounded by the approximation factor of the algorithm. However, in the dual fitting scheme here one may relax the inequalities in the dual program. Therefore, the following exemplary algorithm finds a solution for the primal, and an infeasible solution for the dual with the some value for the objective function. The amount by which the dual inequalities are relaxed (or in other words, the amount by which one must shrink the dual solution so that it fits the dual) will give a bound on the approximation factor of the algorithm. This fact is one basis of the analysis herein.

An Exemplary Algorithm

In this section a notion of time is introduced into the algorithm. The algorithm starts at time 0. At this time, all cities are unconnected, all facilities are closed, and the budget of every city j, denoted by Bⱼ, is initialized to 0.

Act 1: At every moment, each city j offers some money from its budget to each closed facility i. The amount of this offer is computed as follows: If j is unconnected, the offer is equal to max(Bⱼ−cᵢⱼ, 0) (i.e., if the budget of j is more than the cost that it has to pay to get connected to i, it offers to pay this extra budget to i); If j is already connected to some other facility i′, then its offer to facility i is equal to max(c_{i j}−cᵢⱼ, 0) (i.e., the amount that j offers to pay to i is equal to the money that it would save if it switches its facility from i′ to i).

Act 2: While there is an unconnected city, increase the time, and simultaneously, increase the budget of each unconnected city at the same rate (i.e., every unconnected city j has Bⱼ=t at time t), until one of the following events occur (if multiple events occur at the same time, process them in an arbitrary order):

a. For some closed facility i, the total offer that it receives from cities is equal to the cost of opening i. In this case, open facility i, and for every city j (connected or unconnected) which has a non-zero offer to i, connect j to i. The amount that j had offered to i is now called the contribution of j toward i, and j is no longer allowed to decrease this contribution.

b. For some unconnected city j, and some facility i that is already open, the budget of j is equal to the connection cost between j and i. In this case, connect city j to facility i. The contribution of j toward i is zero.

Act 3: For every city j, set αⱼ (the share of j of the total expenses) equal to the budget of j at the end of algorithm. Notice that this value is also equal to the time that j first gets connected.

Notice also that once a city gets connected, one stops increasing its budget. Also, the budget of each connected city is always equal to the connection cost that it pays at the time, plus the total contribution that it has given to the facilities.

At any time during the execution of this exemplary algorithm, the budget of each connected city is equal to its current connection cost plus its total contribution towards open facilities.

Based on the above description of the exemplary algorithm, it can be seen that:

LEMMA 1. The total cost of the solution found by the above algorithm is equal to the sum of αⱼ's.

In order to prove an approximation guarantee of γ, it is enough to show that for every star S, the sum of αⱼ's of the cities in S is at most γ times the cost of S. In order to compute such a γ), an optimization program can be defined (e.g., called the factor-revealing LP) whose solution gives the value of γ. In the subsequent section a factor-revealing LP is used to prove an upper bound of 1.61 on the approximation ratio of the exemplary algorithm above.

The above exemplary algorithm is similar to conventional greedy algorithms, however, rather that having cities stop offering money to facilities as soon as they get connected to a facility, the exemplary algorithm allows cities to still offer some money (e.g., “savings”—the amount that they could save by switching their facility) to other facilities. As a result, the exemplary algorithm finds a solution that cannot be improved just by opening new facilities, and therefore it cannot be improved by conventional greedy augmentation procedures as may other known algorithms.

Deriving an Exemplary Factor-Revealing LP

Various constraints can be expressed that are imposed by the problem or by the structure of the algorithm as inequalities, so that one can determine a bound on the value of γ defined above by solving a series of linear programs.

Consider a star S consisting of a facility of opening cost f (with a slight misuse of the notation, one may call this facility f), and k cities numbered 1 through k. Let dⱼ denote the connection cost between facility f and city j, and αⱼ denote the share of j of the expenses, as defined in the above exemplary algorithm. One may assume without loss of generality that

α₁≦α₂≦ . . . ≦αₖ. (4)

However, one needs more variables to capture the execution of the exemplary algorithm. For every i (1≦i≦k), consider the situation of the algorithm at time t=αᵢ−ε, where ε is very small, i.e., just a moment before city gets connected for the first time. At this time, each of the cities 1, 2, . . . , i−1 might be connected to a facility. For every j<i, if city j is connected to some facility at time t, let r_{j,i} denote the connection cost between this facility and city j; otherwise, let r_{j,i}:=αⱼ. Obviously, the latter case occurs only if αᵢ=αⱼ. It turns out that these variables (f, dⱼ's, αⱼ's, and r_{j,i}'s) are enough to determine some inequalities to bound the ratio of the sum of αⱼ's to the cost of S (i.e., f+Σⱼ₌₁^{k}dⱼ).

First, notice that once a city gets connected to a facility, its budget remains the same and it cannot take back its contribution to a facility, so it can never get connected to another facility with a higher connection cost. This implies that for every j,

r_{j,j+1}≧r_{j,j+2}≧ . . . ≧r_{j,k}. (5)

Now, consider the time t=αᵢ−ε. At this time, the amount of offer of city j toward facility f is equal to:

max(r_{j,i}−dⱼ, 0) if j<i, and

max(t−dⱼ, 0) if j≧i.

Notice that this holds even if j<i and αᵢ=αⱼ. It is clear from the exemplary algorithm that the total offer of cities to a facility can never become larger than the opening cost of the facility. Thus, there is the following inequality:

$${\sum }_{j = 1}^{i - 1} max ( {r}_{j , i} - {d}_{j} , 0 ) + {\sum }_{j = i}^{k} max ( {α}_{i} - {d}_{j} , 0 ) \leq f . \qquad ( 6 )$$

Another important constraint to use is the triangle inequality. By the triangle inequality and the definition of r_{j,i}, for every j<i, the connection cost between city i and the facility to which city j is connected at time t=αᵢ−ε (let's call this facility f′) is at most r_{j,i}+dᵢ+dⱼ. This cost cannot be less than t, since if it is, the exemplary algorithm could have connected the city i to the facility f′ at a time earlier than t, which is a contradiction. Here, one needs to be careful with the special case αᵢ=αⱼ. In this case, R_{j,i}+dᵢ+dⱼ is not more than t. If αᵢ·αⱼ, the facility f′ is open at time t and therefore city i can get connected to it, if it can pay the connection cost. This argument shows that for every 1≦j<i≦k,

αᵢ<r_{j,i}+dᵢ+dⱼ. (7)

The above inequalities form the following optimization program, which is referred to as the factor-revealing LP.

Notice that although the following optimization program is not written in the form of a linear program, one skilled in the art can easily change it to a linear program by introducing new variables and inequalities.

$$maximize \frac{{\sum }_{i = 1}^{k} {α}_{i}}{f + {\sum }_{i = 1}^{k} {d}_{i}} \\ subject to \\ ∀ 1 \leq i < k \text{:} {α}_{i} \leq {α}_{i + 1} \\ ∀ 1 \leq j < i < k \text{:} {r}_{j , i} \geq {r}_{j , i + 1} \\ ∀ 1 \leq j < i \leq k \text{:} {α}_{i} \leq {r}_{j , i} + {d}_{i} + {d}_{j} \\ ∀ 1 \leq i \leq k \text{:} {\sum }_{j = 1}^{i - 1} max ( {r}_{j , i} - {d}_{j} , 0 ) + {\sum }_{j = 1}^{k} max ( {α}_{i} - {d}_{j} , 0 ) \leq f \\ ∀ 1 \leq j \leq i \leq k \text{:} {α}_{j} , {d}_{j} , f , {r}_{j , i} \geq 0 \qquad ( 8 )$$

LEMMA 2: If zₖ denotes the solution of the factor-revealing LP, then for every star S consisting of a facility and k cities, the sum of αⱼ's of the cities in S in the exemplary algorithm is at most zₖc_{S}.

Proof. Inequalities 4, 5, 6, and 7 derived above imply that the values αⱼ,dⱼ,f,r_{j,i} from the exemplary algorithm constitute a feasible solution of the factor-revealing LP. Thus, the value of the objective function for this solution is at most zₖ. □

LEMMA 1 and LEMMA 2 further imply the following:

LEMMA 3: Let zₖ be the solution of the factor-revealing LP, and γ:=supₖ{zₖ}. Then the exemplary algorithm solves the metric facility location problem with an approximation factor of γ.

Solving the Factor-Revealing LP

As mentioned above, the optimization program (8) can be written as a linear program. This enables one to use an LP-solver to solve the factor-revealing LP for small values of k, in order to compute the numerical value of γ. Table 1 below shows a summary of results that are obtained by solving the factor-revealing LP using CPLEX. It appears based on experimental results that zₖ is an increasing sequence that converges to some number close to 1.6 and hence γ≈1.6.

TABLE 1
Solution of the factor-revealing LP

| k | max_{i≦k}zᵢ |
|---|---|
| 10 | 1.54147 |
| 20 | 1.57084 |
| 50 | 1.58839 |
| 100 | 1.59425 |
| 200 | 1.59721 |
| 300 | 1.59819 |
| 400 | 1.59868 |
| 500 | 1.59898 |

By solving the factor-revealing LP for any particular value of k, one gets a lower bound on the value of γ. In order to prove an upper bound on γ, one needs to present a general solution to the dual of the factor-revealing LP. Unfortunately, this is not an easy task in general. For example, performing a tight asymptotic analysis of the LP bound is still an open question in coding theory. However, here empirical results can help. Thus, one may solve the dual of the factor-revealing LP for small values of k to get an idea as to the general optimal solution. Using this, it is usually possible (although sometimes tedious) to prove a close-to-optimal upper bound on the value of zₖ. This technique has been used to prove an upper bound of 1.61 on γ.

One may use the optimal solution of the factor-LP to construct an example on which the exemplary algorithm performs at least zₖ times worse than the optimum. Such results imply the following:

THEOREM 4: The exemplary algorithm herein solves the facility location problem in time O(n³), where n=max(n_{f},n_{c}). Its approximation ratio is equal to the supremum of the solution of the maximization program (8), which is less than 1.61, and more than 1.598.

The Tradeoff Between Facility and Connection Costs

One may define the cost of a solution in the facility location problem as the sum of the facility cost (i.e., total cost of opening facilities) and the connection cost. With the exemplary algorithm above, one can achieve an overall performance guarantee of 1.61. However, sometimes it is useful to get different approximation guarantees for facility and connection costs. The following theorem gives such a guarantee. The proof is similar to the proof of Lemma 3.

THEOREM 5: Let γ_{f}≧1 and γ_{c}:=supₖ{zₖ}, where zₖ is the solution of the following optimization program:

$$maximize \frac{{\sum }_{i = 1}^{k} {α}_{i} - {γ}_{f} f}{{\sum }_{i = 1}^{k} {d}_{i}} \\ subject to \\ ∀ 1 \leq i < k \text{:} {α}_{i} \leq {α}_{i + 1} \\ ∀ 1 \leq j < i < k \text{:} {r}_{j , i} \geq {r}_{j , i + 1} \\ ∀ 1 \leq j < i \leq k \text{:} {α}_{i} \leq {r}_{j , i} + {d}_{i} + {d}_{j} \\ ∀ 1 \leq i \leq k \text{:} {\sum }_{j = 1}^{i - 1} max ( {r}_{j , i} - {d}_{j} , 0 ) + {\sum }_{j = 1}^{k} max ( {α}_{i} - {d}_{j} , 0 ) \leq f \\ ∀ 1 \leq j \leq i \leq k \text{:} {α}_{j} , {d}_{j} , f , {r}_{j , i} \geq 0 \qquad ( 9 )$$

Then for every instance I of the facility location problem, and for every solution SOL for 1 with facility cost F_{SOL} and connection cost C_{SOL}, the cost of the solution found by Algorithm 1 is at most γ_{f}F_{SOL}+γ_{c}C_{SOL}.

A solution has been computed using the optimization program (9) for k=100, and several values of γ_{f} between 1 and 3, to get an estimate of the corresponding γ_{c}'s. Exemplary results are illustrated in the line graph 400 of FIG. 4. Every point (γ_{f},γ′_{c}) on line 402 in this diagram represents a value of γ_{f}, and the corresponding estimate for the value of _{γ}_{c}. Line 404 shows a lower bound that holds unless NP⊂DTIME[n^{O(loglog n)}] and is proved in subsequent sections.

An important advantage here is that all the inequalities ALG≦γ_{f}F_{SOL}+γ_{c}C_{SOL} are satisfied by a single algorithm. As described in the next section, the case γ_{f}=1 can be of particular theoretical interest for designing other algorithms.

Variants of the Problem

The k-median problem differs from the facility location problem in at least two respects: (1) there is no cost for opening facilities, and (2) there is an upper bound k, that is supplied as part of the input, on the number of facilities that can be opened. The k-facility location problem is a common generalization of k-median and the facility location problem. In this problem there is an upper bound k in the number of facilities that can be opened, as well as costs for opening facilities.

The k-medium problem can be reduced to the facility location problem in the following sense: suppose A is an approximation algorithm for the facility 11 location problem. Consider an instance I of the problem with optimum cost OPT, and let F and C be the facility and connection costs of the solution found by A. Algorithm A is called a Lagrangian Multiplier Preserving α-approximation (or LMP α-approximation for short) if for every instance I, C≦α(OPT−F). It can be shown that an LMP α-approximation algorithm for the metric facility location problem gives rise to a 2α-approximation algorithm for the metric k-median problem. This theorem also holds for a common generalization of the metric k-facility location problem.

Hence,

LEMMA 6: An LMP α-approximation algorithm for the facility location problem gives a 2α-approximation algorithm for the k-facility problem.

Here, an LMP 2-approximation algorithm is provided for the metric facility location problem based on the exemplary algorithm described earlier. This will result in a 4-approximation algorithm for the metric k-facility location problem whereas the best previously known was a 6-approximation.

In the capacitated facility location problem, for every facility there is one more parameter, which indicates the capacity of the facility, i.e., the number of cities it can serve. This version of the problem in which one is allowed to open each facility more than once is referred to herein as the capacitated facility location problem with soft capacities.

Conventional techniques for facility location algorithms have shown a 4-approximation capability for the metric capacity facility location problem with soft capabilities. One can generalize such results to the following lemma. This lemma, together with the LMP 2-approximation facility location algorithm gives a 3-approximation algorithm for the metric capacitated facility location problem with soft capabilities.

LEMMA 7: An LMP α-approximation algorithm for the metric uncapacitated facility location problem leads to an (α+1)-approximation algorithm for the metric capacitated facility location problem with soft capabilities.

One can now show that there is an LMP 2-approximation algorithm for the metric facility location problem. The proof is based on Theorem 5 together with known scaling techniques. One can prove the following lemma using this technique.

LEMMA 8: Assume there is an algorithm A for the metric facility location problem that for every instance I and every solution. SOL for I, A finds a solution of cost at most F_{SOL}+αC_{SOL}, where F_{SOL} and C_{SOL} are facility and connection costs of SOL, and a is a fixed number. Then there is an LMP α-approximation algorithm for the metric facility location problem.

For proof, consider the following algorithm: The algorithm constructs another instance I′ of the problem by multiplying the facility opening costs by a, runs the exemplary algorithm (presented earlier) on this modified instance I′, and outputs its answer. Suppose αF (F with the original costs) and C be the facility and the connection costs in the solution provided by this run. Then αF+C≦α(F_{SOL}+C_{SOL}), which implies that this algorithm is an LMP α-approximation.

Now one only needs to prove the following:

THEOREM 9: For every instance I and every solution SOL for I, Algorithm 1 finds a solution of cost at most F_{SOL}+2C_{SOL}, where F_{SOL} and C_{SOL} are facility and connection costs of SOL.

Proof: By Theorem 5 one needs only to prove that the solution of the factor-revealing LP (9) with γ_{f}=1 is at most 2. To do so, one may write the maximization program (9) as the following equivalent linear program:

$$maximize {\sum }_{i = 1}^{k} {α}_{i} - f \\ subject to \\ {\sum }_{i = 1}^{k} {d}_{i} = 1 \\ ∀ 1 \leq i < k \text{:} {α}_{i} - {α}_{i + 1} \leq 0 \\ ∀ 1 \leq j < i < k \text{:} {r}_{j , i + 1} - {r}_{j , i} \leq 0 \\ ∀ 1 \leq j < i \leq k \text{:} {α}_{i} - {r}_{j , i} - {d}_{i} - {d}_{j} \leq 0 \\ ∀ 1 \leq j < i \leq k \text{:} {r}_{j , i} - {d}_{i} - {g}_{i , j} \leq 0 \\ ∀ 1 \leq i \leq j \leq k \text{:} {α}_{i} - {d}_{j} - {h}_{i , j} \leq 0 \\ ∀ 1 \leq i \leq k \text{:} {\sum }_{j = 1}^{i - 1} {g}_{i , j} + {\sum }_{j = i}^{k} {h}_{i , j} - f \leq 0 \\ ∀ i , j \text{:} {α}_{j} , {d}_{j} , f , {r}_{j , i} , {g}_{i , j} , {h}_{i , j} \geq 0 \qquad ( 10 )$$

One then needs to prove an upper bound of 2 on the solution of the above LP. Since this program is a maximum program, it is enough to prove the upper bound for any relaxation of the above program. Numerical results (for a fixed value of k, e.g., k=100) suggest that removing the second, third, and seventh inequalities of the above program does not remove the solution. Therefore, one may relax the above program by removing these inequalities. Now, it is a simple exercise to write down the dual of the relaxed linear program and compute its optimal solution. This solution corresponds to multiplying the third, fourth, fifth, and sixth inequalities of the linear program (10) by I/k, and the first inequality by (2−1/k) and adding up these inequalities. This produces an upper bound of 2⁻¹/k on the value of the objective function. Thus, if γ_{f}=1, then γ_{c}≦2. In fact, γ_{c} is precisely equal to 2, as shown by the following solution for the program (9):

$$\begin{matrix}{α}_{i} = \{ \begin{matrix}2 - 1 / k & i = 1 \\ 2 & 2 \leq i \leq k\end{matrix} \\ {d}_{i} = \{ \begin{matrix}1 & i = 1 \\ 0 & 2 \leq i \leq k\end{matrix} \\ {r}_{j , i} = \{ \begin{matrix}1 & j = 1 \\ 2 & 2 \leq j \leq k\end{matrix} \\ f = 2 ( k - 1 )\end{matrix}$$

This example illustrates that the above analysis of the factor-revealing LP is tight.

Lemma 8 and Theorem 9 provide an LMP 2-approximation algorithm for the metric facility location problem. Those skilled in the art will recognize that this result not only improves on previous results but also provides fairly straightforward algorithms that are adaptable/applicable to various other problems.

Lower Bounds

This section explores some impossibility results. The first result is the following theorem, which together with Feige's result on the hardness of set-cover shows that there is no

$$( 1 + \frac{2}{e} - ϵ )$$

-approximation algorithm for k-median unless NP c DTIME[n^{O(loglog n)}]. The proof is similar to the one used by Guha and Khuller to prove the hardness of the metric facility location problem (see, e.g., S. Guha and S. Khuller, “Greedy Strikes Back: Improved Facility Location Algorithms”, published in the Journal of Algorithms, 31:228-248, 1999).

THEOREM 10: The metric k-median problem cannot be approximated within a factor strictly smaller than 1+2/e unless minimum set-cover can be approximated within a factor of cln n for c<1.

Theorem 10 improves a lower bound of 1+1/e. Notice that Theorem 10 proves that k-median is a strictly harder problem to approximate than the facility location problem because the latter can be approximated within a factor of 1.61.

THEOREM 11: Let γ_{f} and γ_{c} be constants with γ_{c}<1+2e^{-γ}^{_{f}}. Assume there is an algorithm A that for every instance I of the metric facility location problem, A finds a solution whose cost is not more than γ_{f}F_{SOL}+γ_{c}C_{SOL} for every solution SOL for 1 with facility and connection costs F_{SOL} and C_{SOL}. Then minimum set-cover can be approximated within a factor of cln n for c<1.

Line 404 in FIG. 4 shows the lower bound provided by the above theorem. The above theorem shows that finding an LMP

$$( 1 + \frac{2}{e} - ϵ ) \text{-} approximation$$

for the metric facility location problem is hard. Also, known integrality gap examples show that Lemma 6 is tight. This shows that one cannot use Lemma 6 as a black box to obtain a smaller factor than

$$2 + \frac{4}{e}$$

for the k-median problem. Note that a 3+ε approximation is already known for the problem. Hence if one wants to improve this factor using the Lagrangian relaxation technique then it will be necessary to look into the underlying LMP algorithm as already been done, for example, by Charikar and Guha (see, e.g., M. Charikar and S. Guha, “Improved Combinatorial Algorithms For Facility Location and k-Median Problems”, published in Proceedings of the 40^{th} Annual IEEE Symposium on Foundations of Computer Science, 378-388, October 1999).

The Factor-Revealing LP Technique

This section further elaborates on the techniques of using factor-revealing LPs used to analyze the algorithms presented herein. This section demonstrates this technique by applying it in combination with dual fitting to a classical greedy algorithm for the set cover problem. This section also explains how one can use computers to predict and prove bounds on the solution to the factor-revealing LP.

A re-statement of the greedy algorithm for the set cover problem is as follows. All uncovered elements raise their dual-variables until a new set S goes tight (e.g., its cost equals the sum of the values of the dual variables of its elements). At this point, the set S is picked. Newly covered elements pay for the cost of S with their dual values. In doing so, they withdraw their contributions offered towards the cost of any other set. This ensures that at the end of the algorithm the total contribution of the elements is equal to the sum of the cost of the picked sets. However, one might not get a feasible dual solution. To make the dual solution feasible, one may look for the lowest positive number Z, so that when the dual solution is shrunk by a factor of Z, it becomes feasible. An upper bound on the approximation factor of the algorithm is obtained by maximizing Z over all possible instances. This known technique is referred to as dual fitting. With this in mind, focus will now be placed on the factor-revealing LP technique which is used to estimate the value of Z.

Clearly Z is also the maximum factor by which any set is over-tight.

Consider any set S. One can determine the worst factor, over all sets and over all possible instances of the problem, by which a set S is over-tight. Let the elements in S be 1, 2, . . . , k. Let xᵢ be the dual variable corresponding to the element i at the end of the algorithm. Without loss of generality we may assume that x₁≦x₂≦ . . . ≦xₖ. It is easy to see that at time t=xᵢ⁻, total duals offered to S is at least (k−i+1)xᵢ. Therefore, this value cannot be greater than the cost of the set S (denoted by c_{S}). The optimum solution of the following mathematical program gives an upper bound on the value of Z (note that c_{S} is a variable not a constant):

maximize

$$\frac{{\sum }_{i = 1}^{k} {x}_{i}}{{c}_{s}} \qquad ( 11 )$$

subject to

∀1≦i<k: xᵢ≦xᵢ₊₁

∀1≦i≦k: (k−i+1)xᵢ≦cₛ

∀1≦i≦k: xᵢ≧0

cₛ≧1

The above optimization program can be turned into a linear program by adding the constraint c_{S}=1 and changing the objective function to Σᵢ₌₁^{k}xᵢ. The linear program is essentially a “factor-revealing LP”. Notice that the factor-revealing LP has nothing to do with the LP formulation of the set cover problem; it is only used in order to analyze this particular algorithm. This is an important distinction between the factor-revealing LP technique, and other LP-based techniques in approximation algorithms.

Once one formulates the analysis of the algorithm as a factor-revealing LP, then one can use computers to empirically compute the upper bound given by the factor-revealing LP on the approximation ratio of the algorithm. This is very useful, since if the empirical results suggest that the factor-revealing LP does not produce a good approximation ratio, then one may try adding other inequalities to the factor-revealing LP. For this one might introduce new variables to capture the execution of the algorithm more accurately. For example, in an earlier section above, variables r_{j,i} were introduced to get a good bound on the approximation ratio of the algorithm.

The next step is to analyze the factor-revealing LP and derive an upper bound on the value of its solution. For the set cover example above, this step is fairly trivial since the factor-revealing LP associated with the algorithm is quite simple. However, in general this can be a difficult step of the proof. Here, for example, one can employ computers to get ideas about the proof, as explained below. Proving Theorem 4 would have been very difficult without using these techniques.

Since the factor-revealing LP provides an upper bound on the approximation ratio of the algorithm, one can relax some of the constraints of the LP to make it simpler. After each relaxation, one can use computers to verify that this relaxation does not change the value of the objective function drastically. After simplifying the factor-revealing LP in this way, one can find an upper bound on its solution by finding a feasible solution for its dual for every k. Again, here one can use a computer to solve the dual linear program for a couple hundred values of k, to observe, for example, a trend in the values of the optimal dual solution. After guessing a sequence of dual solutions, one has to theoretically verify their feasibility. For complicated linear programs, additional parameters may be included to help guess a general dual solution in terms of these parameters and optimize over the choice of these parameters at the end.

Note that in general this technique does not guarantee the tightness of the analysis, because sometimes the algorithm performs well not because of local structures but for some global reason(s). Sill, in many cases one may get a tight example from a feasibly solution of the factor-revealing LP. For example, from any feasible solution of the factor-revealing LP (11), one can construct the following instance: There are k elements 1, . . . , k, a set S={1, . . . , k} of cost 1+ε which is the optima solution, and sets Sᵢ={i} of cost xᵢ for i=1, . . . , k. It is easy to verify that the algorithm works Σxᵢ times worse than the optimal in this instance. This means that the approximation ratio of the set cover algorithm is precisely equal to the solution of the factor-revealing LP, which is Hₙ.

Graphical Depiction of Facilities/Resources and Clients

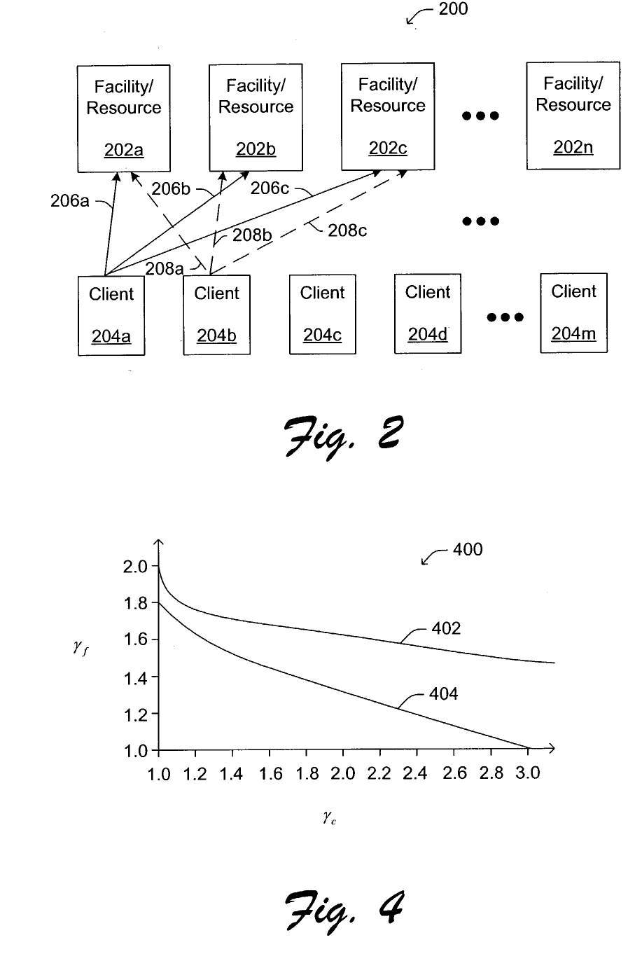

Given the teachings of the exemplary mathematical techniques and algorithms in the previous sections, attention is now drawn to FIG. 2, which is a block diagram illustratively depicting a setting 200 having a plurality of possible facilities/resources 202, a plurality of clients 204 that the algorithm assigns or otherwise associates each with at least one of the facilities/resources 202, and “costs” for the client to access or otherwise use a facility/resource represented by the exemplary interconnecting arrows 208, in accordance with certain exemplary implementations of the present invention.

As shown, client 204a in this example is able to access or otherwise use facility/resources 202a with a “cost” of 206a, facility/resources 202b with a “cost” of 206b, and facility/resources 202c with a “cost” of 206c. Client 204b is able to access or otherwise use facility/resources 202a with a “cost” of 208a, facility/resources 202b with a “cost” of 208b, and facility/resources 202c with a “cost” of 208c.

The term “cost” is used in this section to represent at least one parameter associated with the effort, expense, time, distance, etc., that is required of the client 204 to properly access or otherwise use a possible facility/resource as intended.

In FIG. 2, for example, when considering a facility location problem each facility 202a-n represents a potential suitable location for a facility. By way of example, facility 202a-n may represent potential locations to build new retail grocery stores within a city. The clients 204a-m in this example could represent retail shoppers that live in and around the city. The costs (e.g., 206a-c, 208a-c) in this example may represent the travel time for the respective client 204 to access each respective facility 202. The facility location problem in this example would be to determine which facility or facilities to build to adequately serve the clients. Ideally, the resulting facility building expenses would be minimized or otherwise kept low, while also providing a “cost” efficient solution for the intended clients. The algorithm provided herein tends to select facilities that tend to provide the lowest average costs.

In another example, when considering a resource allocation problem, such as, data servers, each resource 202a-n represents a potential suitable point/location for a data server. By way of example, resources 202a-n may represent potential points/nodes/locations to build new data servers within one or more networks. Clients 204a-m in this second example could represent other computers/devices that access the network resources including the data servers. The costs (e.g., 206a-c, 208a-c) in this second example may represent the communication effort for the respective client 204 to access each respective resource 202. The resource allocation problem in this example would be to determine which resources should be established to adequately serve the clients. Ideally, the resulting resource expenses would be minimized or otherwise kept low, while also providing a “cost” efficient solution for the intended clients. The exemplary algorithm described herein tends to select resources that provide the lowest average costs. Note that the term “client” used in this example in a more generic sense and as such is not meant to limit the other computers/devices to actual client devices as often used in client-server relationships.

An Exemplary Flow-Diagram

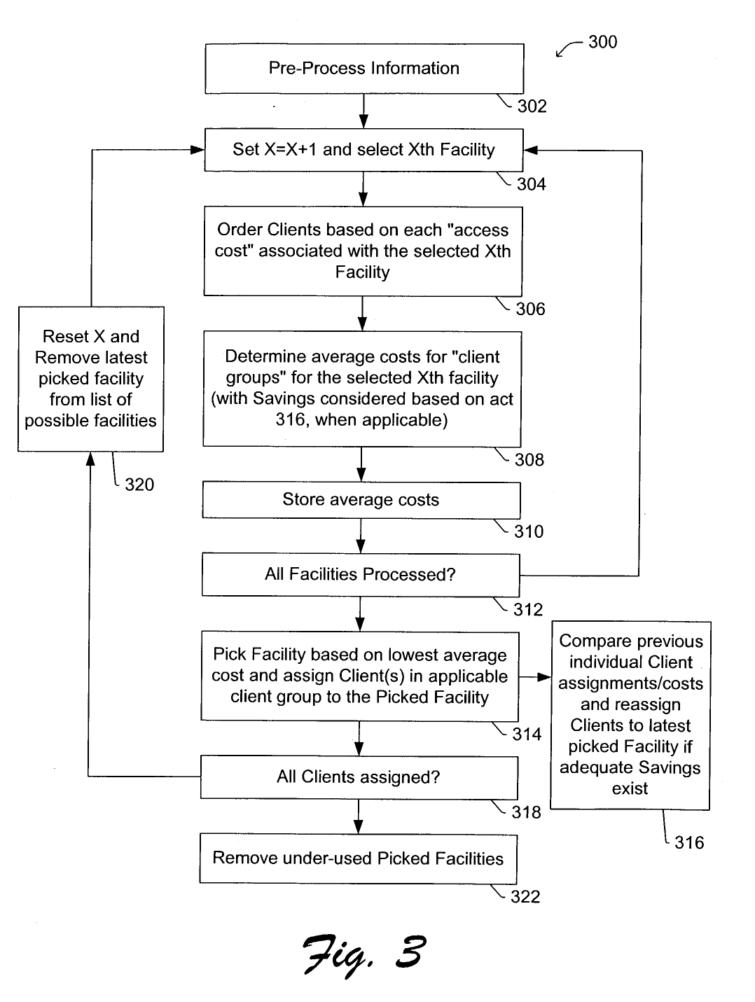

With the graphical representation of FIG. 2 in mind and also considering the previously described algorithm features, attention is drawn next to FIG. 3, which is a flow diagram depicting a method 300 for a facility/resource algorithm that can be implemented in logic, in accordance with certain exemplary implementations of the present invention.

In act 302 information about the facilities/resources, clients, and/or costs are processed, entered, estimated, etc., in preparation for the other acts in method 300.

Note that method 300 represents an iterative process, so a counting variable X is use in this example to help illustrate some of the iteration. Other iteration techniques may be employed. In act 304, X is set to X+1 and the X^{th} facility/resource is selected for consideration.

In act 306, the clients are placed in order based on cost for the selected X^{th} facility/resource. In act 308, the average cost for the selected X^{th} facility/resource is determined for “client groups”. Client groups include one or more clients. Thus, for example, one client group would include the first client (as ordered in act 306), another client group would include the first and second clients (again, as ordered in act 306), and yet another client group would include first, second and third clients (also as ordered in act 306). This exemplary client grouping technique basically adds the next client in the order to the next client group, and a plurality of client groups are considered, with the last client group including all of the clients. In act 310 the average costs for the selected X^{th} facility/resource is stored.

In act 312, if all of the facilities to be considered have been considered, then method 300 continues to act 314, otherwise method 300 iterates back to act 304 and the next facility/resource (X+1) is considered via acts 304-312.

In act 314, a facility/resource is “picked” based on the stored cost information from step 310, e.g., the lowest average cost client group. This picked facility/resource is associated with the client(s) in the applicable client group such that the facility/resource is a candidate for building and the applicable clients are assigned to it.

Assuming that this is the first picked facility/resource, then method 300 continues with act 318, wherein it is determined if all of the clients have been assigned to a facility/resource. If there are still some clients that have yet to be assigned to a facility/resource, then in method 300 returns to act 304 via act 320. In act 320, the counting mechanism X is reset to 0 and the latest picked facility/resource is removed from the list of possible facilities/resources. Then, acts 304 through 314 are conducted and another facility/resource is picked and one or more clients assigned to it.

In act 316, a local comparison is conducted for assigned clients and the facilities/resources picked thus far to determine if one or more of the clients can be reassigned to another picked facility/resource to save costs. Thus, for example, if client 204b was originally assigned to facility 202a, and now facility 202c has also been picked and assigned other clients, then in act 316 a comparison of costs 208a and 208c is made to determine if client 204b should be reassigned to client 204c. In this example, let us assume that cost 208a for client 204b to access facility 202a has a value of “150”, and cost 208c for client 204b to access facility 202c has a value of “120”. Then, it makes sense to reassign client 204b to facility 202c since there is a savings of 150-120=30. Such “savings” may also be considered in act 308 during subsequent cost determinations.

Once all of the clients have been assigned to a facility/resource, then in act 322 picked facilities that no longer have clients assigned to them are removed as build candidates. Also, in act 322, decisions can be made to reassign clients from under-used facilities/resources to other build candidate facilities/resources. Thus, for example, if picked (build candidate) facility 202a only has two clients assigned to it and the other picked (build candidate) facilities have hundreds of clients each, then each of the clients assigned to facility 202a may be reassigned to another facility and facility 202a essentially “unpicked”. Thus, act 322 may include logic to ensure that certain threshold criteria are satisfied by the resulting picked (build candidate) facilities.

### CONCLUSION

The above novel algorithm presented herein provides further improvements over previously known results dependent upon the contemporary primal-dual algorithm. In particular, for example, in certain implementations, the improved algorithm provides a factor 4 for K-median problems, and a factor 1.57 for the incapacitated facility location problem. To get these even more outstanding results, for example, one may further implement scaling of the facility costs via preprocessing and eventually complete a local search and greedy augmentation in the end.

Although the invention has been described in language specific to structural features and/or methodological acts, it is to be understood that the invention defined in the appended claims is not necessarily limited to the specific features or steps described.

What is claimed is:

1. A method suitable for use in a computing device, the method comprising:
a) identifying a plurality of potential resources;
b) identifying a plurality of users and for each of said users an access parameter for each of said potential resources;
c) for each of said potential resources, establishing a plurality of user groups and determining a corresponding group access parameter, wherein each of said user groups includes at least one of said users;
d) selecting one of said group parameters, wherein said selected group parameter has associated with it a corresponding potential resource and a corresponding user group;
e) re-identifying said corresponding potential resource as a candidate resource;
f) assigning each user in said corresponding user group to said candidate resource, if said user is not already assigned to another candidate resource;
g) if a plurality candidate resources have been identified, then for each user assigned to one of said candidate resources consider re-assigning said user to a different one of said candidate resources based at least on a comparison of access parameters associated with said user and each of said candidate resources; and
h) repeating c) through g) until each of said users has been assigned to a corresponding candidate resource.

2. The method as recited in claim 1, wherein identifying said plurality of potential resources further includes:
for each of said potential resources, identifying a corresponding initiating parameter.

3. The method as recited in claim 2, wherein said initiating parameter includes a cost parameter associated with said potential resource.

4. The method as recited in claim 3, wherein said cost parameter represents a monetary cost of providing said potential resource.

5. The method as recited in claim 2, wherein establishing said plurality of user groups further includes:
arranging said potential resources based on at least each potential resources corresponding initiating parameter.

6 The method as recited in claim 5, wherein arranging said potential resources further includes:
arranging said potential resources in an ascending order based on each of said potential resources corresponding initiating parameter.

7. The method as recited in claim 1, wherein establishing said plurality of user groups further includes:
for each of said potential resources, arranging said users based on each of said users said access parameter.

8. The method as recited in claim 7, wherein, for each of said potential resources, arranging said users based on each of said users said access parameter further includes:
arranging said users in an ascending order based on each of said users said access parameter.

9. The method as recited in claim 7, wherein determining said corresponding group access parameter further includes:
determining said corresponding group access parameter based on said access parameters associated with each said user in said user group.

10. The method as recited in claim 9, wherein determining said corresponding group access parameter based on said access parameters further includes:
averaging said access parameters associated with each said user in said user group.

11. The method as recited in claim 2, wherein selecting one of said group parameters further includes:
comparing all of said group parameters and selecting a lowest value group parameter.

12. The method as recited in claim 11, wherein each of said group parameters is further based on said initiating parameter for said associated potential resource.

13. The method as recited in claim 11, wherein at least one of said group parameters is further based on access parameter savings associated with having previously re-assigned in g) at least one of said users in said corresponding user group to said different candidate resource.

14. The method as recited in claim 1, wherein at least one of said potential resources includes at least one resource selected from a group of resources comprising a facility, a building, a platform, a business location, a store, an office, a warehouse, a factory, a medical facility, a port, a service capability, a computing resource, a server, a communication resource, an antenna, a satellite, an information repository, a database, a public utility resource, a natural resource, a crop, a supply, a transportation resource, an education resource, and an entertainment resource.

15. The method as recited in claim 1, wherein at least one of said potential resources includes at least one physical item suitable for being accessed by at least one of said users.

16. The method as recited in claim 1, wherein at least one of said potential resources includes at least one service suitable for being accessed by at least one of said users.

17. The method as recited in claim 1, wherein at least one of said users includes at least one type of user selected from a group of users comprising at least one person, a group of people, a business, a consumer, a client, geographically-related resource users, a city, an entity, an organization, a student, a patient, a subscriber, an animal, a computing device, a computer program, a communication device, a receiver, a transmitter, and a transportation device.

18. The method as recited in claim 1, wherein at least one of said users includes at least one item suitable for accessing at least one of said potential resources.

19. The method as recited in claim 1, wherein for each of said users said access parameter includes a user cost parameter associated with accessing said potential resource.

20. The method as recited in claim 19, wherein said user cost parameter is associated with at least one cost selected from a group of costs comprising a monetary cost, a time cost, a distance cost, and a travel cost.

21. The method as recited in claim 1, further comprising:
after completing h) if one of said candidate resources does not have at least one of said users assigned to it, then re-identifying said candidate resource as one of said potential resources.

22. The method as recited in claim 1, further comprising:
identifying a minimal candidate resource threshold; and
after completing h) for each said candidate resource, determine if said candidate resource satisfies said minimal candidate resource threshold based on the number of said users assigned to said candidate resource, and if said candidate resource does not satisfy said minimal candidate resource threshold then:
for each said user assigned to said candidate resource, re-assign said user to another one of said candidate resources based at least on said access parameters associated with said user, and
re-identify said candidate resource as one of said potential resources.

23. The method as recited in claim 1, further comprising after h) outputting a list of said candidate resources.

24. The method as recited in claim 23, further comprising outputting a list of user groups assigned to each of said outputted candidate resources.

25. The method as recited in claim 23, further comprising outputting a list of users assigned to each of said outputted candidate resources.

26. A computer-readable medium having computer implementable instructions for configuring at least one processing unit to perform acts comprising:
a) identifying a plurality of potential resources;
b) identifying a plurality of users and for each of said users an access parameter for each of said potential resources;
c) for each of said potential resources, establishing a plurality of user groups and determining a corresponding group access parameter, wherein each of said user groups includes at least one of said users;
d) selecting one of said group parameters, wherein said selected group parameter has associated with it a corresponding potential resource and a corresponding user group;
e) re-identifying said corresponding potential resource as a candidate resource;
f) assigning each user in said corresponding user group to said candidate resource, if said user is not already assigned to another candidate resource;
g) if a plurality candidate resources have been identified, then for each user assigned to one of said candidate resources consider re-assigning said user to a different one of said candidate resources based at least on a comparison of access parameters associated with said user and each of said candidate resources; and
h) repeating c) through g) until each of said users has been assigned to a corresponding candidate resource.

27. The computer-readable medium as recited in claim 26, wherein identifying said plurality of potential resources further includes:
for each of said potential resources, identifying a corresponding initiating parameter.

28. The computer-readable medium as recited in claim 27, wherein said initiating parameter includes a cost parameter associated with said potential resource.

29. The computer-readable medium as recited in claim 28, wherein said cost parameter represents a monetary cost of providing said potential resource.

30. The computer-readable medium as recited in claim 27, wherein establishing said plurality of user groups further includes:
arranging said potential resources based on at least each potential resources corresponding initiating parameter.

31 The computer-readable medium as recited in claim 30, wherein arranging said potential resources further includes:
arranging said potential resources in an ascending order based on each of said potential resources corresponding initiating parameter.

32. The computer-readable medium as recited in claim 26, wherein establishing said plurality of user groups further includes:
for each of said potential resources, arranging said users based on each of said users said access parameter.

33. The computer-readable medium as recited in claim 32, wherein, for each of said potential resources, arranging said users based on each of said users said access parameter further includes:
arranging said users in an ascending order based on each of said users said access parameter.

34. The computer-readable medium as recited in claim 32, wherein determining said corresponding group access parameter further includes:
determining said corresponding group access parameter based on said access parameters associated with each said user in said user group.

35. The computer-readable medium as recited in claim 34, wherein determining said corresponding group access parameter based on said access parameters further includes:
averaging said access parameters associated with each said user in said user group.

36. The computer-readable medium as recited in claim 27, wherein selecting one of said group parameters further includes:
comparing all of said group parameters and selecting a lowest value group parameter.

37. The computer-readable medium as recited in claim 36, wherein each of said group parameters is further based on said initiating parameter for said associated potential resource.

38. The computer-readable medium as recited in claim 36, wherein at least one of said group parameters is further based on access parameter savings associated with having previously re-assigned in g) at least one of said users in said corresponding user group to said different candidate resource.

39. The computer-readable medium as recited in claim 26, wherein at least one of said potential resources includes at least one resource selected from a group of resources comprising a facility, a building, a platform, a business location, a store, an office, a warehouse, a factory, a medical facility, a port, a service capability, a computing resource, a server, a communication resource, an antenna, a satellite, an information repository, a database, a public utility resource, a natural resource, a crop, a supply, a transportation resource, an education resource, and an entertainment resource.

40. The computer-readable medium as recited in claim 26, wherein at least one of said potential resources includes at least one physical item suitable for being accessed by at least one of said users.

41. The computer-readable medium as recited in claim 26, wherein at least one of said potential resources includes at least one service suitable for being accessed by at least one of said users.

42. The computer-readable medium as recited in claim 26, wherein at least one of said users includes at least one type of user selected from a group of users comprising at least one person, a group of people, a business, a consumer, a client, geographically-related resource users, a city, an entity, an organization, a student, a patient, a subscriber, an animal, a computing device, a computer program, a communication device, a receiver, a transmitter, and a transportation device.

43. The computer-readable medium as recited in claim 26, wherein at least one of said users includes at least one item suitable for accessing at least one of said potential resources.

44. The computer-readable medium as recited in claim 26, wherein for each of said users said access parameter includes a user cost parameter associated with accessing said potential resource.

45. The computer-readable medium as recited in claim 44, wherein said user cost parameter is associated with at least one cost selected from a group of costs comprising a monetary cost, a time cost, a distance cost, and a travel cost.

46. The computer-readable medium as recited in claim 26, further comprising:
after completing h) if one of said candidate resources does not have at least one of said users assigned to it, then re-identifying said candidate resource as one of said potential resources.

47. The computer-readable medium as recited in claim 26, further comprising:
identifying a minimal candidate resource threshold; and
after completing h) for each said candidate resource, determine if said candidate resource satisfies said minimal candidate resource threshold based on the number of said users assigned to said candidate resource, and if said candidate resource does not satisfy said minimal candidate resource threshold then:
for each said user assigned to said candidate resource, re-assign said user to another one of said candidate resources based at least on said access parameters associated with said user, and
re-identify said candidate resource as one of said potential resources.

48. The computer-readable medium as recited in claim 26, further comprising after h) outputting a list of said candidate resources.

49. The computer-readable medium as recited in claim 48, further comprising outputting a list of user groups assigned to each of said outputted candidate resources.

50. The computer-readable medium as recited in claim 48, further comprising outputting a list of users assigned to each of said outputted candidate resources.

51. An apparatus comprising:
logic operatively configured to identify a plurality of potential resources, a plurality of users, and for each of said users an access parameter for each of said potential resources, and wherein said logic is further configured repeatedly perform the following acts until each of said users has been assigned to a corresponding candidate resource:
a) for each of said potential resources, establish a plurality of user groups,
b) for each of said user groups, determine a corresponding group access parameter, wherein each of said user groups includes at least one of said users,
c) select one of said group parameters, wherein said selected group parameter has associated with it a corresponding potential resource and a corresponding user group,
d) re-identify said corresponding potential resource as a candidate resource,
e) assign each user in said corresponding user group to said candidate resource, if said user is not already assigned to another candidate resource, and
f) if a plurality candidate resources have been identified, then for each user assigned to one of said candidate resources determine, based at least on a comparison of access parameters associated with said user and each of said candidate resources, whether to re-assign said user to a different one of said candidate resources.

52. The apparatus as recited in claim 51, wherein said logic is further configured to, for each of said potential resources, identify a corresponding initiating parameter.

53. The apparatus as recited in claim 52, wherein said initiating parameter includes a cost parameter associated with said potential resource.

54. The apparatus as recited in claim 53, wherein said cost parameter represents a monetary cost of providing said potential resource.

55. The apparatus as recited in claim 52, wherein, when establishing said plurality of user groups, said logic is further configured to arrange said potential resources based on at least each potential resources corresponding initiating parameter.

56 The apparatus as recited in claim 55, wherein, when arranging said potential resources, said logic is further configured to arrange said potential 18 resources in an ascending order based on each of said potential resources corresponding initiating parameter.

57. The apparatus as recited in claim 51, wherein, when establishing said plurality of user groups, said logic is further configured to, for each of said potential resources, arrange said users based on each of said users said access parameter.

58. The apparatus as recited in claim 57, wherein, for each of said potential resources, said logic arranges said users based on each of said users said access parameter by arranging said users in an ascending order based on each of said users said access parameter.

59. The apparatus as recited in claim 57, wherein, when determining said corresponding group access parameter, said logic is further configured to determine said corresponding group access parameter based on said access parameters associated with each said user in said user group.

60. The apparatus as recited in claim 59, wherein, when determining said corresponding group access parameter based on said access parameters, said logic is further configured to average said access parameters associated with each said user in said user group.

61. The apparatus as recited in claim 52, wherein, when selecting one of said group parameters, said logic is further configured to compare all of said group parameters and select a lowest value group parameter.

62. The apparatus as recited in claim 61, wherein each of said group parameters is further based on said initiating parameter for said associated potential resource.

63. The apparatus as recited in claim 61, wherein at least one of said group parameters is further based on access parameter savings associated with said logic having previously re-assigned in f) at least one of said users in said corresponding user group to said different candidate resource.

64. The apparatus as recited in claim 51, wherein at least one of said potential resources includes at least one resource selected from a group of resources comprising a facility, a building, a platform, a business location, a store, an office, a warehouse, a factory, a medical facility, a port, a service capability, a computing resource, a server, a communication resource, an antenna, a satellite, an information repository, a database, a public utility resource, a natural resource, a crop, a supply, a transportation resource, an education resource, and an entertainment resource.

65. The apparatus as recited in claim 51, wherein at least one of said potential resources includes at least one physical item suitable for being accessed by at least one of said users.

66. The apparatus as recited in claim 51, wherein at least one of said potential resources includes at least one service suitable for being accessed by at least one of said users.

67. The apparatus as recited in claim 51, wherein at least one of said users includes at least one type of user selected from a group of users comprising at least one person, a group of people, a business, a consumer, a client, geographically-related resource users, a city, an entity, an organization, a student, a patient, a subscriber, an animal, a computing device, a computer program, a communication device, a receiver, a transmitter, and a transportation device.

68. The apparatus as recited in claim 51, wherein at least one of said users includes at least one item suitable for accessing at least one of said potential resources.

69. The apparatus as recited in claim 51, wherein for each of said users said access parameter includes a user cost parameter associated with accessing said potential resource.

70. The apparatus as recited in claim 44, wherein said user cost parameter is associated with at least one cost selected from a group of costs comprising a monetary cost, a time cost, a distance cost, and a travel cost.

71. The apparatus as recited in claim 51, wherein said logic is further configured to re-identify at least one of said candidate resources as one of said potential resources if said at least one candidate resource does not have at least one of said users assigned to it.

72. The apparatus as recited in claim 51, wherein said logic is further configured to:
identify a minimal candidate resource threshold; and
after assigning all of said users, for each said candidate resource, determine if said candidate resource satisfies said minimal candidate resource threshold based on the number of said users assigned to said candidate resource, and if said candidate resource does not satisfy said minimal candidate resource threshold then:
for each said user assigned to said candidate resource, re-assign said user to another one of said candidate resources based at least on said access parameters associated with said user, and
re-identify said candidate resource as one of said potential resources.
